(19) United States
(12) Patent Application Publication
(10) Pub. No.: US 2010/0076891 A1
(43) Pub. Date: Mar. 25, 2010

(54) Superior identification system by changing word or number codes

(76) Inventor: Arthur Vanmoor, Miami, FL (US)

Correspondence Address: Hoffman, Wasson & Gitler, P.C., Suite 522, 2461 South Clark Street, Arlington, VA, 22202, US

(21) Appl. No.: 12/458,267

(22) Filed: Jul. 7, 2009

Related U.S. Application Data
(63) Continuation-in-part of application No. 12/453,128, filed on Apr. 29, 2009.
(60) Provisional application No. 61/136,656, filed on Sep. 23, 2008.
(60) Provisional application No. 61/193,033, filed on Oct. 23, 2008.
(60) Provisional application No. 61/202,413, filed on Feb. 26, 2009.
(60) Provisional application No. 61/202,769, filed on Apr. 2, 2009.
(60) Provisional application No. 61/213,244, filed on May 20, 2009.

(51) Int. Cl. G06Q 20/00; G06Q 40/00; H03M 11/00; G06F 17/30

(52) U.S. Cl. 705/44; 341/22

(57) ABSTRACT

A system and method for identification purposes or for preventing unauthorized use of a credit/debit card and its numbers. For each new transaction, a new PIN code is needed. After usage, the code is deleted and the card and its numbers cannot render a transaction until a new code has been established. The PIN code can consist of numbers, letters or a word. The user/card holder can be in charge of generating each new code. When entering the code, a new code can be entered at the same time which replaces the last code. The new code could also be entered at a later time by using a phone or the internet. During communication between parties over, such as a telephone or over the internet, only a portion of the card number would be included in the communication, along with a predetermined password. In an enhanced version intercepting the new code or seeing what digits are used by the card holder would be worthless since a secret digit only known by the true cardholder would have to be added to the last code when used for the next transaction. The system also describes a manner of quickly entering letters on an existing numbered keypad. In this manner, easy to remember words can be used.

### CROSS-REFERENCE TO RELATED APPLICATIONS

The present application claims the benefit of U.S. patent application Ser. No. 12/453,128, filed Apr. 29, 2009, as well as U.S. Provisional Patent Application Ser. No. 61/136,656, filed on Sep. 23, 2008, as well as U.S. Provisional Patent Application Ser. No. 61/193,033, filed on Oct. 23, 2008, as well as U.S. Provisional Patent Application Ser. No. 61/202,413, filed on Feb. 26, 2009, as well as U.S. Provisional Patent Application Ser. No. 61/202,769, filed on Apr. 2, 2009, as well as U.S. Provisional Patent Application Ser. No. 61/213,244, filed on May 20, 2009. The subject matter of the five provisional patent applications, as well as the parent application are incorporated by reference herewith.

### BACKGROUND OF THE INVENTION

The present invention relates to an identification system using numbers, letters, words, and other characters included on a keyboard. This could be used to enter a secured area or for debit/credit card, charge card or any other financial transactions, or for any other identification purposes. Most widely used is a similar system in the credit/debit card industry. However, these existing systems are very receptive to fraud. The credit card industry has dramatically failed to solve these problems. The present invention has overcome these problems, especially with interne transactions in which the card is not present and only the numbers are given to the merchant.

At present, when a credit card or debit card transaction is made at a merchant's place of business, the merchant would slide the credit card or debit card through a terminal. Additionally, particularly when a credit or debit card is used at an ATM location, the owner of the card would input a personal identification number (PIN). The terminal would then automatically dial a toll free number connecting the terminal to a computer at a computer center. The computer would automatically check the available balance of the card as well as to verify the ownership utilizing the PIN. The computer at the computer center would contact the merchant's terminal with either an approval code or an indication that the transaction has been declined. It is noted that this system is vulnerable to fraud, stolen cards or copycat cards. Consequently, if a thief has absconded with an individual's credit or debit card and is in possession of that individual's PIN, the credit card could be utilized to conduct a rather large number of transactions as well as, with respect to a debit card, drain the individual's bank account.

Consequently, a number of U.S. patent applications have been filed and patents have issued on various systems to make it difficult or impossible for a thief to effectively utilize an individual's stolen credit or debit card.

For example, U.S. Pat. No. 5,478,994, as well as U.S. Pat. No. 5,627,855, both issued to Rahman et al describes a system utilizing a credit card including a programmable read only memory (PROM) containing a series of stored randomly generated numbers, each number representing a unique PIN, each PIN used for only a single transaction. A host computer is provided with the same identical PINs as included on the PROM. Therefore, when a transaction is made, one of the PIN numbers is transmitted to the host computer which verifies that the transaction is valid based upon a comparison of the transmitted PIN with one of the PINs included in the memory of the host computer.

U.S. Pat. No. 5,251,259, issued to Mosley, illustrates a personal identification system for use with a credit card. A group of seven PINs are assigned to each card holder. This series of PINs would be maintained in a PIN memory provided in the computer at the credit card company. If a PIN is used out of sequence, the access to the credit card would be denied by the credit card company.

U.S. Pat. No. 7,051,929, issued to Li, details a secure credit card employing a security number changed on a daily basis. A process is provided on the credit card loaded with a predetermined program to generate the proper security number. A computer provided at the credit card company would also maintain this predetermined program for computing the security number which is compared to the security number generated and transmitted to the credit card company.

U.S. Patent Application Publication No. 2004/0241183, as well as U.S. Pat. Nos. 7,246,752; 7,380,710 and 7,472,829, all in the name of Brown, describe a system in which a new PIN code is provided for every transaction.

U.S. Pat. Nos. 7,448,538 and 7,472,827, issued to Fletcher, illustrate a system in which a limited use PIN is associated with a primary account.

None of the references describes a concept whereby the user/card holder himself generates and chooses each next new PIN code to be used. The prior art is still subject to fraud because either the credit card gets stolen with the secret information on the magnetic strip, or the same PIN code is re-occurring in some way. There is presently no prior art directed to preventing fraud with internet and/or mail order transactions. Also, no prior art discloses the use of letters or words instead of number codes.

### SUMMARY OF THE INVENTION

The present invention overcomes the deficiencies of the prior art by providing an individual with a system allowing the individual to utilize a credit or debit card with confidence that, if that card or the credit card number is stolen, it would be impossible for the thief to effectively utilize the card or its numbers to the detriment of the card owner or the issuing bank. The present invention uses a PIN code having words or letters that is constantly changing and generated and chosen by the user/card holder. Every time the PIN code having words or letters is requested for a purchase, the user enters or supplies also the next PIN code he/she wants to be used for the next transaction. In an enhanced version, the next new PIN code to be generated must be used in combination with a formula such as adding a secret digit or digits. This version prevents fraudulent uses in cases in which the next new PIN code or word code could become in possession of an unauthorized user. Only the true user/card holder knows the new PIN code an the secret digit or digits. It is important to note that any keyboard symbol can be used for the secret digit or digits, as well as the PIN. The symbols would include numbers, letters and special characters. Please note in use in this application, the term PIN code would include the use of words and letters.

In a simplified version without the use of a secret digit, or a formula, the following example is illustrative of the invention. If the initial PIN is 454, then the PIN to be used at the first merchant is 454. At the same time, the next new PIN must be then conveyed to the credit card company or bank's database for storage therein. In this example, if the next PIN to be chosen is 853, then 853 can be entered in two different ways. One manner of entering this number would be to combine the previous PIN with the new PIN as one number. In this example, this would be done by inputting 454853 at one time. Alternatively, this can be done by inputting 454 first and then to wait or pause for a command and then enter 853. Using this scenario, wherein the user employs new numbers as a random PIN, the numbers could be entered either all at once or with a pause as follows: 853-345. The next transaction would be 345-777. The following transaction would be 777-271. The following transaction would be 271-444. The next transaction would be 444-855 and so on.

When using words, such as the following example, if the first transaction uses the two words DOG/CAT; the next transaction would be CAT/PINK; the following transaction would be PINK/TABLE; the next transaction would be TABLE/PHONE; and so on. A method will be subsequently described for quickly entering letters on a standard number keypad.

The present invention insures the safety of any transaction conducted at a merchant's terminal, over the internet, or by phone by requiring that an individual card owner pick a secret digit or digits which would be utilized in a certain manner, for instance by adding this to the initial PIN code. In this scenario, the card holder when applying for the issuance of a card would supply the credit card company or a bank with this secret digit or digits. The credit card company would then supply the card holder with an initial PIN along with the credit or debit card. Thereafter, when the card holder makes an initial purchase, the card holder would enter the initial PIN and add the secret digit or digits, thereby creating a new and matching PIN. At the bank/credit card center, this new PIN would be compared with the combination of the initial PIN and the card holder's secret digit or digits. If there is a match between the combination of the initial PIN and the secret digit or digits which is computed as a new PIN in the computer's memory, the transaction would be consummated.

When the card holder enters his new PIN code, which is the last one used, plus the added secret digit or digits at the same time, the next new PIN is entered. At the computer center, the secret digit gets added and this new PIN would then be entered into the computer's memory. Thereafter, when the card holder wishes to make another purchase, the card holder would enter the combination of the last PIN added with the secret digit or digits. If the comparison indicates that the new PIN (including the secret digit or digits) agrees with the numbers stored in the database, the transaction would be consummated. In this manner, if a thief steals the card owner's credit or debit card, it would be useless since even if they were in possession of the initial PIN code generated by the credit card company prior to any purchases being made, it would be virtually impossible for the thief to enter the combination of the last PIN used and the secret digit or digits.

As can be appreciated, while the present invention would prevent fraudulent purchases to be made, for the system to work properly, it is important that the card user remember the secret digit or digits and the formula used such as adding as well as the last random PIN that was entered. These numbers, letters or words should either be memorized by the card user or written down. It does not matter if a thief becomes in possession of the credit card and/or its numbers and the PIN code because it is worthless as long as the thief does not know the secret digit or digits. Since these secret digits are never given to anyone (only initially to set up the card with the bank), there is no way a thief can get in possession of them. This system is virtually 100% fraud proof. It does not matter whether a camera is spying on the terminal when the card holder enters the credit card numbers and PIN numbers or words. Without the secret digit or digits, any future transaction would fail to make a match since only at the database memory is the correct true PIN on file. For the secret digits, one could choose a birthday from someone or a lucky number, or any other significant number.

For example, if the secret digit is 8 and the formula is “adding” with a starting PIN of 558, then the card holder should use a PIN 564 (558+8) in order to obtain a match with the PIN stored in the database of the computer center associated with the bank or credit card company. The user would then transmit a new PIN to the database by entering the old PIN along with a new random PIN. In this example, if the new random PIN is chosen to be 212, then the user would enter 564-212 as a single input or with a pause between the old PIN and the new PIN. For instance, the 212 could be entered when the terminal states a command or request to do so. In a preferred embodiment, this could be done all at once such as 564212 or with a dash (-) or any other keyboard symbol such as a star (*). Subsequent transactions would be, for example, 220-555. The next transaction would be 563-947. The following transaction would be 953-888. The next transaction would be 896-707. The following transaction would be 715-484 and so on. It is noted that an 8 was added to all of the new PINs.

### BRIEF DESCRIPTION OF THE DRAWING

FIG. 1 illustrates a block diagram of the system according to the present invention;

FIG. 2 shows a standard keypad;

FIG. 3 shows a standard computer keyboard; and

FIG. 4 shows using a secret digit to enter a code word.

### DETAILED DESCRIPTION OF THE PRESENT INVENTION

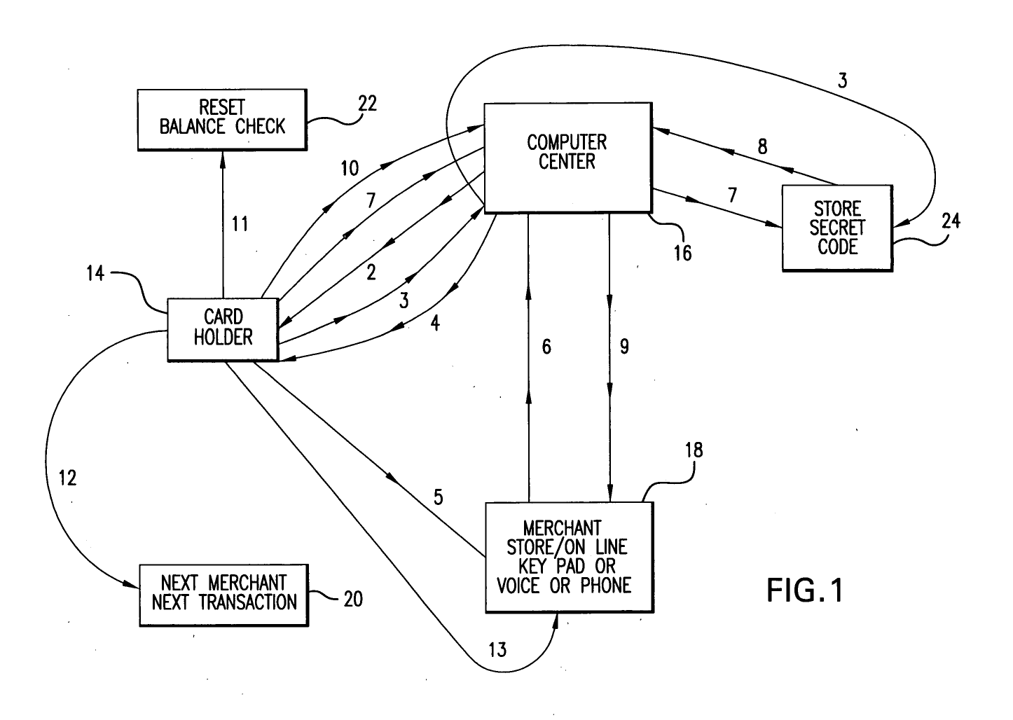

FIG. 1 illustrates the system which is utilized with the present invention. This diagram includes the various principles that are needed as well as illustrating the steps involved in practicing the present invention. Initially, an individual 14 who wishes to obtain a debit or credit card would request an application at Step 1 from a credit card company 16. This application would be requested in many ways such as receiving a solicitation in the mail, or actively asking the credit card company via the internet or a telephone request to send an application for a credit card or debit card to the potential card holder 14. This application would then be sent by the credit company and received by the card holder at Step 2. The card holder would then complete the application and send it back to the credit card company at Step 3. It is important that in the application a request is made for a preferred and easy to remember secret digit or digits and the preferred choice of formula, for instance, adding, that would be utilized along with either an initialized PIN generated by the credit card company and sent to the card holder or utilizing an initialized PIN created by the card holder and sent to the credit card company. The credit card company 16 would then send the credit or debit card to the card holder 14 at Step 4. If the credit card company 16 created the initial PIN, both that initial PIN as well as the secret digit or digits and formula of choice would be provided to the credit card company 16 by the card holder 14 would be stored in a computer 24 in communication with the credit card company 16. If the credit card company 16 did not provide the initial PIN to the credit card holder 14, this initial PIN would also be generated by the card holder 14 and transmitted to the credit card company 16 where it would be stored in the computer 24 along with the secret digit or digits and the formula, for instance, adding.

In one alternative of the present invention, the card holder can now use the initial or lastly generated PIN to make a purchase at a merchant's establishment 18, either in person utilizing a key pad, or through the internet or a telephone call at Step 5. At this point, the card holder would input or supply the new PIN code. This new PIN code is the combination, for instance, adding, from the last entered (or started) PIN with the added secret digit or digits. At the same time, a new PIN code is also entered which will be the basis for the next future transaction. Again, the last PIN code needs to be used in the future by simply adding the secret digit or digits to it. If the transaction was made at the merchant's place of business, the card holder's credit or debit would be swiped at a terminal. If the purchase was made by telephone, the card holder would either enter the card number using his or her keypad or the number would be entered verbally with the PIN code and new PIN. Similarly, if an internal purchase were made, the card number would be entered using a computer keypad. After a purchase, the card holder 14 would then proceed to the next merchant at 18 and enter the last PIN added with the secret digit or digits. The combination of the PIN and the secret digit or digits would then be transmitted to the computer company at Step 6. The credit card company 16 would then transmit the PIN to the computer 24 to compare this number with the combination of the last PIN added with the secret digit or digits stored in the computer at Step 7. If there is a match, Step 8 would then transmit the approval to the credit card company 16 and if approval is warranted because there are funds available, approval would then be transmitted to the merchant 18 would inform the card holder that the transaction has been consummated. If no match is made, the credit card company would inform the merchant that the transaction cannot be consummated.

Once approval has been given to the card holder 14 from the merchant 18, the card holder 14 can transmit to the computer center 16 and the computer 24 a new PIN entered into the computer at Step 9. This new PIN can be transmitted to the credit card company 16 in many ways, including utilizing a key pad provided at a merchant's location or utilizing the card holder's computer keypad to transmit this new PIN to the credit card company 16. This can be done by transmitting the previously used PIN used in combination with the formula used on file, for instance, “adding” with the secret digit or digits along with the new PIN. Thereafter, this new PIN is in the computer 24 used in combination with the formula and the end result is stored in the database and is ready for comparison for use in a new transaction 11 with another merchant 20 at Step 10. The PIN and the new PIN to be chosen will also be inserted all at one time.

Another manner in which the next new PIN can be generated is without making a purchase. The card holder 14 through the use of Step 11 would, for example, check the balance of their credit card or debit card at for example, an independent keypad 22, by calling a toll free telephone number provided by the credit card company, bank or computer center or security office, in case it involves entering a secured area. At this point, once the new PIN is recorded, the next transaction can be consummated at Step 12 from a new merchant 20 or from the initial merchant 18 at Step 13. This embodiment is important, since if a new PIN is given to a merchant, that merchant could inform the user that a transaction was approved, when in reality the merchant would use the PIN with the credit card number to make their own purchase. Changing the PIN number in between use by calling a toll free number would prevent any potential fraudulent use by merchants. Additionally, when the credit card number is used back to back at the same location such as a secured area or with the same merchant, it is recommended to change the PIN in between these transactions. The user simply calls a toll free number from a cell phone after the transaction has taken place and changes the PIN. Hereafter the PIN is 100% secure and the system is fully fraudulent resistant.

In another yet further enhanced version of the system, the user gives the issuer of the credit card or security company one or two code words, for instance “pepper” and “trumpet”. After the user enters his PIN at a merchant or secured location, the system communicates back with a command such as “pepper, enter new PIN”. Subsequently, this new PIN is entered. The next command could say “trumpet, PIN locked”. Now the user knows for certain that the new PIN code is secured and stored, since only the authentic credit card or security company knew these code words.

For those users who seem to forget their last entered PIN, or who prefer not to write down or store the last PIN or simply lost it, the following enhancement could be helpful. The user contacts the credit/debit card company, for instance by phone or the interne, then enters the card number and a predetermined code word agreed upon for identification purposes. The system knows that only the true user has this code word and will give out the PIN that needs to be used in the next transaction. This PIN was the PIN last entered by the user himself/herself. In the version with the secret digit, the secret digit would still need to be added to this PIN in order to match.

In yet another version, the user does not supply a new PIN code when making a new transaction, but for instance enters 000 or another pre-agreed number “block”. Also, the system can be set up in such a manner that a PIN code can only be used for one transaction. In this case the card gets blocked for further use, until the user contacts the credit/debit card company and identifies himself as the true user with the special pre-agreed upon code word. The user is then requested to enter a new PIN. Alternatively, the computer can generate a new PIN. Contacting the credit/debit card company should preferably be made shortly before the next transaction is anticipated to happen. This special code word should never be given out by the user to anyone other than the credit/debit card company, and is predetermined when the account is set up, preferably by a word picked by the user. This version can be used with our without adding any secret digits. If a user suspects that transactions might be intercepted, then it is recommended to contact the credit/debit card company after every transaction and change the PIN. Either of the two parties to a transaction can change any PIN code, or, a third party can change any of the PIN codes.

Therefore, the teachings of the present invention would make it very difficult for a thief to utilize a card holder's credit or debit card or the card number for use on the internet since the secret digit or digits is only known by the individual credit card owner and the credit card company and is never ever given out. If a thief or dishonest merchant picks up the new PIN code, he/she really does not have the next usable PIN code since he/she does not know what secret number to add on to form the real new useable PIN. The PIN that was entered as the new PIN is by itself worthless without further knowledge of the secret digit or digits. Since the secret digit or digits are never revealed, this system is virtually 100% fully fraud proof. All of the PINs as well as secret digits could consist of numbers, letters, special characters or a combination of all three.

Additionally, if a thief would intercept the credit or debit card mailed by the credit card company, which also could include the initial PIN, the thief would be unable to utilize the credit card with the PIN for any transaction since the thief would not be in possession of the secret digit or digits and the formula to use it. It is noted that the secret digit or digits can be applied to the initial PIN or any subsequent PIN by any arithmetic computation, such as, but not limited to, addition, subtraction, multiplication or division.

The following example is to be used to explain the system of the present invention. Assuming that the individual credit card owner has designated the number “24” as their secret digits and adding as preferred computation feature and, that when the credit card company has supplied the individual card holder with a particular credit or debit card, the company has also designated that the initial PIN to be 123. Then, at this point, the individual credit card owner can make a purchase using any means possible, such as visiting a merchant's establishment, contacting the merchant by telephone or through the internet. Once the individual credit card owner's card has been swiped at the merchant's terminal, the individual credit card owner would enter the number 147 based upon adding the secret digits “24” to the initial PIN 123. The number 147 would then be transmitted to the credit card company which would then check this number against the PIN stored in the credit card company's computer. The PIN stored in the computer is the last PIN or starter PIN with the secret digit or digits added on to it, in this case 147 was in memory. If there is a match, the purchase would be approved, if funds are available, and all other criteria are met.

When making a purchase, it is preferred that the individual credit card owner enter a new PIN. Generally, this number is entered after the old PIN which is the last PIN with the added secret digit or digits. Therefore, using the previously entered PIN of 147 (123+24), the individual credit card owner would enter a new PIN such as 666 which is transmitted to the credit card company's computer. This new number 666 is added to the secret digit 24 resulting in a new PIN of 690 (666+24). Thus, when the individual credit card owner wishes to make a second purchase, the number 690 would be entered. This number is then transmitted to the credit card company after which a comparison is made to the new PIN stored in the company's computer.

Prior to the next purchase made by the individual credit card owner, said owner would enter the number 690 plus any other number such as 111. This new number 111 when added to 24 would produce the next PIN, i.e. 135 and so on. The individual card holder can end this cycle by simply entering a preset number, such as the first number in the cycle which in this case is 123. This would block any initial utilization of the card since no new PIN is on file.

Additionally, although the present invention has been described with the utilization of a three digit PIN, the present invention is not so limited and the changeable PIN could include a number of digits as can the secret digit or digits. At the present time, most, if not all merchants have only a numbered key pad making it impossible to use a PIN code consisting of words to be entered therein. The present invention overcomes this problem. The solution therefore is explained in yet another embodiment of the present invention, which would allow a customer to enter code words rather quickly utilizing a standard numbered keypad. Hereafter it will be explained in more detail how words can be used instead of numbers. Also, numbers or words could be properly generated by a database or credit card company.

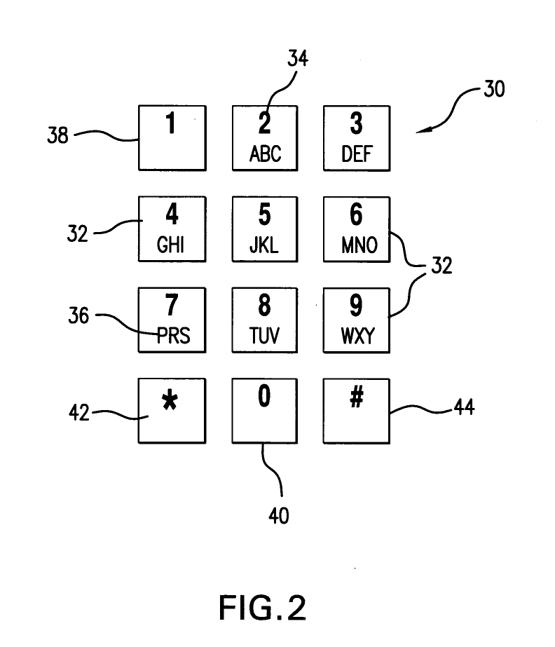

Currently, most keypads as shown in the telephone are illustrated in FIG. 2. Keypads used on ATMs and the merchant's terminal are similar but do not have letters on the keys. This keyboard 30 contains a plurality of buttons 32 provided with a single number 34 thereon as well as a series of three letters such as PRS 36. Button 38 is only provided with the numeral 1 and button 40 is only provided with the numeral 0. A special star key 42 as well as the pound key 44 are also included in a standard keypad.

At the present time, there are no systems which include letters or words on standard ATMs or merchant terminals, nor are there systems and/or instructions on how to use words or letters on these existing numbered keypads. This is true since special software would be needed. An existing system used in text messaging employs pauses to indicate which letter on a particular keypad button was designated by the user. The software used in text messaging translates the numbers with pauses into the specific letter chosen by the user. Even if new terminals and/or software were substituted for existing ATM merchant terminals, or cash registers, the system would be too slow to be effective.

Since the existing ATM and merchant key pads do not have letters, a simple solution would be to place a transparent layer over the keypad with letters printed on the transparent layer. Alternatively, a diagram or picture can be placed on the back of the credit card illustrating which letter belongs to which key.

The present invention overcomes the deficiencies of this type of text messaging since no pauses are required. By employing the scenario according to the present invention, one can utilize the number keypad to create letters, words and text. These letters, words and texts can be used in conjunction with the secret digits to create the code words previously described in the present application. For example, the word “dog” is entered on the keyboard shown in FIG. 2 by depressing in succession the 36664 keypad buttons. Therefore, button 6 was depressed three times in succession without any pause, with the number 4 which designates the “G” pressed right after the last 6.

When transmitted from one location to another, such as from a merchant's transaction keypad, it could be done as a live stream with no conversion to letters or text. A receiver provided at a remote location such as the computer center 16 shown in FIG. 1 would convert the numbers back to letters. A partial conversion from the keypad numbers to a particular number are shown below.

| | | | |
|---|---|---|---|
| 2 = A | 3 = D | 4 = G | 5 = J |
| 22 = B | 33 = E | 44 = H | 55 = K |
| 222 = C | 333 = F | 444 = I | 555 = L |

A problem occurs if successive letters are entered which are on the same single button 32. For example, if one were to transmit the word “beet”, one would have to input the combination 2233338. Due to the inclusion of four consecutive threes, the computer would be unable to determine whether the four threes were DF, FD or EE. To clear up this confusion, the 1 button 38 would be employed. This button would be used to properly separate the combination of the four successive threes used to transmit the word “beet”. In this instance, the correct combination of digits would be 22331338 thereby separating the first two threes from the last two threes. In this instance, the computer would recognize each of the two threes as the letter “e” thereby converting this combination of numbers into the word “beet”.

Additionally, the 1 button 38 as well as the 0 button 40 could be used as shown below to provide for the missing letters Q and Z as well as for different grammatical symbols.

| 0 = space inbetween words | 1 = divider and “glue” |
|---|---|
| 00 = Q | 11 = . period |
| 000 = Z | 111 = , comma |
| 0000 = ″ | 1111 = ( open bracket |
| 00000 = : | 11111 = ) closed bracket |
| 000000 = ; | |

The star key 42 could be used to indicate that a particular letter should be in the upper case with the pound key 44 indicating that subsequent letters should be in the lower case.

For example, utilizing this type of algorithm, the city “Miami” would be designated as *6#44426444. The word “mono” would be designated as 616661661666.

As previously described, the present invention utilizes a secret digit or digits, in many cases a number and a PIN code that is constantly changing and generated and chosen by the user/card holder. A problem with this algorithm is that the user/card holder must remember the last PIN code. It is undoubtedly easier if the last code to be recalled by the user/card holder would be a word and not a number. As described with respect to the keypad shown in FIG. 2, the present invention describes a method of quickly entering a word to be used as the PIN code. Unfortunately, the merchant, or other person could determine the word that is entered by utilizing the standard keypad. Therefore, a system must be devised in which the secret digit or digits would be employed to mask the entered code word. For example, if the first code word to be entered on the keypad shown in FIG. 2 would be “blue”, the numbers 225558833 would be pressed in succession. If the new code word was RADIO, the numbers 7723444666 would be pressed in succession. However, if a numerical digit or digits such as 5 would be used in conjunction with entering the password “five”, that number could be entered as 772225588 since each of the buttons pressed to enter this number would be five buttons to the right of each of the buttons which would be normally used to input the word BLUE. Instead of moving five keys to the right, another way of entering the word BLUE would be to move five letters to the left. In this instance, the word BLUE would be entered by pressing the numbers 47725 in succession. In this instance, the word “blue” became GRAJ.

Yet another algorithm would be to utilize multiple numbers as the secret digits. For example, if the secret digits were 123 and the first password was BLUE, the first letter B would be moved to the next button, the second letter L would be moved two buttons, the third letter U would be moved three buttons and the fourth letter E, since the secret number only contains three digits, would remain the same. Therefore, in this scenario, BLUE would be entered by 337733133, since the 1 would be used to divide the last two letters.

Another way of entering the word BLUE would be to move each letter to the right based upon the secret digits 123. In this instance, the letter B would become a C, the letter L would become an N, the letter U would become an X and the letter E would remain the same. Therefore, BLUE would become CNXE and would be entered as 222669933.

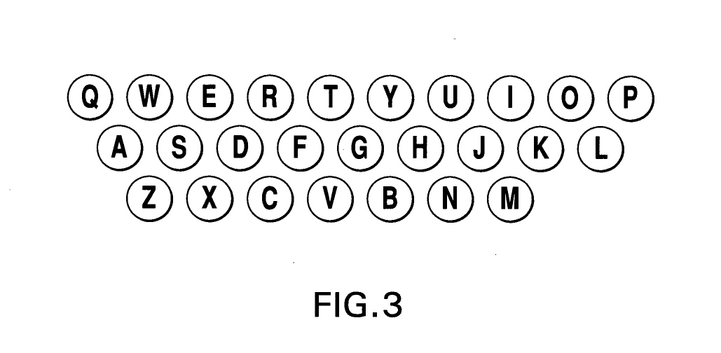

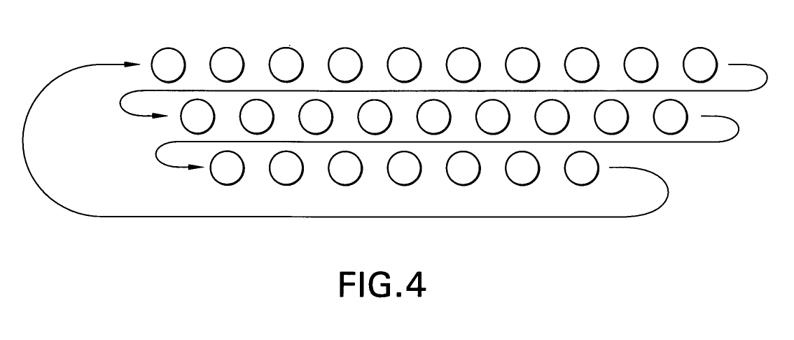

The idea of utilizing a secret digit or digits to move letters on a keypad can also be extended to a typewriter or computer keyboard which would be utilized online to do internet shopping. It will be easy just to enter the starter code word which could be MONKEY and then type the next new word such as STAR. A subsequent code word could be STAR-SUN, followed by SUN-CAT, followed by CAT-FARM, followed by FARM-TRUCK and so on. FIG. 3 shows a standard computer keyboard and FIG. 4 shows the manner in which each letter would be moved based upon a secret digit such as 5. In this instance, if the starter code word was CAT, employing the digit 5 as a secret digit would mean that all of the letters to form the word CAT would be moved five spaces to the right as shown in FIG. 4 in which CAT becomes QHP. If the secret digit 5 meant that each of the letters would move five spaces to the left, then the word CAT would become a second combination of three letters. It can be appreciated that the secret digit could move the letters upwards or downwards as well as other sequences. Since if a single digit is used as the secret digit moving the letters to the right, it might be easy to discern the starter password or any subsequent password, a plurality of digits, such as 452 would be used with the word CAT. In this instance, instead of the word CAT, the letters MHU would be entered since the letter C would be moved four keys to the right, the letter A would be moved five keys to the right, and the letter T would be moved two keys to the right.

In another improvement the credit/debit card holder with multiple cards can choose to utilize a version whereby all codes will be constantly changed and synchronized. Thus, one code word would be valid on any of the user's cards. If one code is changed using a credit card, it is automatically changed for all of the user's credit cards.

In another version, the use of any of the described inventions and systems in this application could be applied to those transactions whereby no credit card is present, in which only the numbers are conveyed to the merchant, such as internet and phone order purchase.

Another improvement is that part or all of the credit card numbers would be replaced by letters or words or other characters.

Alternatively, the credit/debit ATM card or identification card and/or its numbers can be used with a word code or number code whereby the code is valid for one, two, three or more transactions. Also, the code could be valid for up to a certain money amount. For instance, each code could allow up to $500 in purchases. Also a minimum amount could be agreed upon by the parties, for instance, $50 and under this amount the code would not get erased and no new code would need to be established. Alternatively, two or more code words or numbers could be stored simultaneously in the database memory in advance.

The present invention describes a method of providing secure transactions using credit/debit cards at an ATM, merchant's terminal, through a mail order transaction or over the interne. It is important that the public be given an incentive to use the teachings of the present invention. Therefore, it is suggested to send to every existing credit/debit card owner an invitation to use this new “feedback” card. Some customers will be sent the card directly and others must reply to the invitation.

The new credit/debit card would be similar to, or a clone of, the user's existing credit card except that the new “feedback” card would have a different number or would utilize the same number with an indication that it is a clone. For example, an additional, 17th digit could be utilized, or one or more of the existing credit/debit card numbers could be changed. If this was the case, it would be preferable that a first digit or a digit in the first set of four digits could be used for the clone.

The user would now have the use of two cards which would be usable at the choice of the user. Both of these cards can be drawn against the same bank account or credit/debit card account. A billing summary generated for the two cards would indicate which purchase was made by the existing card and which purchase was made by the “feedback” card. The object of this scenario is to have the customer overcome their fear of using a new system and/or being without a usable card.

The existing card would operate as normal, allowing the user to experiment utilizing the second card and to acclimate itself to the more complicated, but much more secure system.

It is suggested that the user employ the “feedback” card on high risk transactions such as utilizing the internet and mail order purchases. Since these transactions are usually made from the user's home or office, the user would not be rushed to try the new system and the code word could be written and easily and safely stored.

When the “feedback” card is sent to the cardholder, the cardholder would be required to activate the card. The identification of the true card holder would be accomplished in the regular manner. For instance, the bank or credit card company could request the user to identify various prior purchases or the names of merchants that they have utilized.

Upon activation of the card, the user is given by the bank or credit card company a certain code which should be remembered or recorded and stored safely. A preferred embodiment of the present invention has suggested that the initial code word, or code number is valid for only a single transaction. Once this transaction has been completed, the card and these code words or code numbers are blocked from use. The user must now reactivate the card by telephoning the bank or credit card company. Alternatively, the bank or credit card company can be accessed online. When the card user contacts the bank, the entire credit card number should not be communicated with the company but only a partial series of the numbers should be given, such as the first 12 numbers along with the aforementioned initial code number or code word. In that manner, the cardholder would be protected if the telephone call or internet communication is intercepted. In this instance, the thief would not have the full credit card number in its possession.

Whether the bank or credit card company is contacted by telephone or online, the user would then be directed to an automatic system or would speak to an employee of the bank or credit card company. The user would then be requested to choose one of various options related to a new code. These options would include that the user should pick a code word, a code number or the new code would be randomly generated by a database and then given to the user.

Alternatively, the credit card company or bank could be the entity that contacts the user by automatically calling a phone number after the last transaction, or by contacting the card holder through the internet. Since there is no valid code between a previous transaction and establishing a new code, the credit/debit or ATM card is completely fraud proof.

While the present invention has been described with respect to particular embodiments, it can be appreciated that changes can be made to the invention within the proper scope of the description. For example, although the present invention has been described with respect to making different purchases or obtaining money from an ATM, any time a terminal is used to allow an individual to obtain something or to enter into a particular area, the use of a changeable PIN with or without the utilization of the secret digit or digits can be employed. A new code can be established at any time after the transaction or entering a secured area. A telephone or computer can be used to do so. Furthermore, the use of this invention to enter a security area, according to the present invention, can be accomplished even without the use of any regular identification.

What is claimed is:

1. A method of utilizing a personal identification code comprising the steps of:
initially utilizing a first personal identification code by a user; and
said user generating a new personal identification code for every subsequent use.

2. The method in accordance with claim 1, further including the step of:
triggering an approval of each personal identification code when each personal identification number used with a predetermined formula and a secret digit or digits.

3. A method for approving a secured transaction between one or more parties, comprising the steps of:
creating a first code consisting of one or more digits;
creating a second code consisting of one or more digits;
creating a formula for the first and second codes;
applying the formula on the first and second codes resulting in the creation of a new code;
storing said new code;
comparing an incoming transaction with a code with said new code; and
approving or denying a transaction between parties, based upon said comparing step.

4. A method for approving a secure transaction between one or more parties, comprising the steps of:
comparing a code stored in a database with an entered code; and
entering a set of digits generating a new code and erasing the previous stored code.

5. The method in accordance with claim 1, whereby a system separates part of the digits for comparison with the existing stored code and the other part to be used to create a new code.

6. A method for creating a secure transaction between a credit or debit card owner and a bank or credit card company, comprising the steps of:
opening an account with the bank or credit card company by said card owner;
creating an initial code stored in a database in communication with the bank or credit card company;
utilizing said initial code to make a first purchase through the credit card company or make a withdrawal from the bank;
comparing said initial code provided in said utilizing step with said initial code stored in said database;
approving said first purchase or withdrawal when said initial code in said utilizing step matches said initial code stored in said database;
transmitting a subsequent code to said database to replace said initial code in said database;
endeavoring to make a second purchase or withdrawal by said card owner by sending said subsequent code to said database;
comparing said subsequent code sent by said card owner when endeavoring to make said second purchase or withdrawal with said subsequent code stored in said database; and
approving said second purchase or withdrawal when said subsequent code supplied in said endeavoring step matches said subsequent code provided in said database.

7. The method in accordance with any one of claim 1, 3, 4 or 6, wherein said subsequent code is transmitted to said database along with said initial code.

8. The method in accordance with any one of claim 1, 3, 4 or 6, further including the step of said card owner initially supplying a secret digit or digits to said database to be applied to said initial and subsequent codes stored in said database as well as to be applied to said initial code during said utilizing step.

9. The method in accordance with claim 8, further including the step of applying said secret digit or digits to said subsequent code in said transmitting step.

10. The method in accordance with claim 8, wherein said secret digit or digits are added or subtracted to said initial and subsequent codes.

11. The method in accordance with any one of claim 1, 3, 4 or 6, wherein said first and new personal identification codes are entered or supplied all at once.

12. The method in accordance with any one of claim 1, 3, 4 or 6, wherein said first and new personal identification codes are entered or supplied as two separate codes.

13. The method in accordance with either claim 1 or 2, wherein said first and new personal identification codes comprise keyboard symbols consisting of numbers and/or letters and/or special characters.

14. The method in accordance with claim 6, including the step of generating said subsequent code when the balance of the credit card or debit card is checked.

15. The method in accordance with claim 6, including the step of generating said subsequent code by utilizing a telephone or the interne to reach the bank or credit card company.

16. A method of securing a transaction between first and second parties, comprising the steps of:
providing a plurality of characters;
storing said characters in a database;
creating a word or number code;
erasing said code when a match of said word or number code is made.

17. A method of entering a code containing a series of letters using a standard keypad provided with a plurality of first buttons, each of the buttons including a plurality of letters and a single number and at least one second button including a number or non letter character, comprising the steps of:
a) depressing or contacting one of said first buttons one or more times based upon the position of the first letter of the code provided on said one of said first buttons to enter the first letter of the code using the keypad;
b) depressing or contacting one of said first buttons one or more times based upon the position of the second letter of the code provided on said one of said first buttons to enter the second letter of the code using the keypad;
c) entering the remaining letters of the code as recited in step a) until all of the letters of the code were entered using the keypad.

18. The method of entering a code in accordance with claim 17, further including the step of depressing or contacting one of said second buttons between entering adjacent code letters when said adjacent code letters are found on the same first button of the keypad.

19. The method in accordance with claim 18, wherein one of said second buttons only includes the numeral 1.

20. The method in accordance with claim 17, wherein one of said second buttons containing a non letter character is depressed or contacted prior to entering a particular letter of the code to designate that said particular letter is capitalized.

21. The method in accordance with claims 17, further including the steps of:
assigning a single numeral digit X to be used in conjunction with entering the code; and
entering each letter of the code by depressing or contacting one of said first buttons X buttons to the left or right of the one of said first buttons provided with each letter of the code.

22. The method in accordance with claim 17, further including the steps of:
assigning a plurality of numerical digits to be used in conjunction with entering the code, the number of numeral digits corresponding to the number of letters in the code; and
entering each letter of the code by depressing or contacting one of said first buttons to the left or right of the one of said buttons provided with each letter of the code consistent with the specific number of said plurality of numerical digits corresponding to each particular letter of the code.

23. A method of entering a code containing a series of letters using a standard typewriter or computer keyboard provided with a plurality of lettered keys, comprising the steps of:
assigning a single numeral digit X to be used in conjunction with entering the code; and
entering each letter of the code by depressing or contacting one of said lettered keys X keys to the left or right of the key provided with each letter of the code.

24. The method in accordance with claim 23, further including the steps of:
assigning a plurality of numerical digits to be used in conjunction with entering the code, the number of numeral digits corresponding to the number of letters in the code; and
entering each letter of the code by depressing or contacting one of said lettered keys to the left or right of the lettered keys provided with each letter of the code consistent with the specific number of said plurality of numerical digits corresponding to each particular letter of the code.

25. A method of promoting the use of a credit/debit card operating with a changeable code, comprising the steps of:
an issuer of credit/debit cards sending to a customer having an existing credit/debit card, a new credit/debit card, the identification number of the new credit card being virtually identical to the identification number of said existing credit/debit card, said new credit/debit card using a first personal identification code for its first use and changeable identification codes for subsequent uses of said new credit card; and
encouraging the customer to use said new credit/debit card for high risk mail order and interest transactions.

26. The method in accordance with claim 25, wherein the customer chooses a combination of numbers, letters or words for said changeable identification codes.

27. The method in accordance with claim 25, further including the step of said customer contacting said issuer using only a portion of said identification number of said new credit/debit card along with said changeable code.

28. A method for communicating between credit/debit card issue and cardholder comprising the steps of:
establishing a code word or number code;
issuing a credit/debit card number; and
communicating using only part of the card number in combination with said established code.

29. The method in accordance with any one of claim 3, 4, 6, 23, 25 or 28, wherein a user with more than one credit/debit card an have all cards synchronized as to the use of code.

30. The method in accordance with any one of claim 3, 4, 6, 23, 25 or 28, wherein the system as described is only used on those transactions when a credit/debit card is not present.

31. The method in accordance with any one of claim 3, 4, 6, 23, 25 or 28, wherein a predetermined spending limit is established for each code before the coded gets erased.

32. A method of utilizing a personal identification code for a plurality of credit/debit cards comprising the steps of:
initially utilizing a first personal identification code by a user;
said user generating a new personal identification code for every subsequent use;
synchronizing the use of said new personal identification code for each of the plurality of credit/debit cards.

33. A method of utilizing a personal identification code comprising the steps of:
initially utilizing a first personal identification code by a user;
said user generating a new personal identification code for every subsequent use;
establishing a predetermined maximum limit for each code; and
preventing the use of each code when said maximum limit is reached.

34. A method for approving a secured transaction between two parties, comprising the steps of:
establishing a number of letter combination;
establishing a first code;
storing said combination and codes in a database;
communicating said codes from one party to a second party;
allowing only transactions to be approved when a match is made of said codes;
when a match is made thereby erasing said first code.

35. A method in accordance with claim 34, wherein a new code can be established rendering the approval system valid when the new code in the database matches a the entered code.

36. A method for approving or denying a transaction between two parties, comprising the steps of:
comparing a code stored in a database with an entered code;
approving a transaction when said entered code matches said code stored in the database; and
erasing said code stored in the database.

37. The method in accordance with claim 36, including the step of storing said entered code in the database.

38. A method for approving or denying a transaction between two parties, comprising the steps of:
utilizing words instead of numerical PIN codes for an approval process;
comparing an entered word with a word stored in a database;
approving the transaction when an entered word or portion of an entered word matches a word or portion of a word stored in the database.

39. A method of utilizing a personal identification code comprising the steps of:
initially utilizing a first personal identification code by a user;
said user generating a new personal identification code for every subsequent use; and
establishing a predetermined minimum limit for each code under which the code would not be erased.

40. A method of utilizing a personal identification code comprising the steps of:
initially utilizing a first personal identification code by a user; and
a bank or credit card company generating a new personal identification code for every subsequent use.

41. A method of utilizing a personal identification code comprising the steps of:
initially utilizing a first personal identification code by a user;
said user generating a new personal identification code for every subsequent use; and
the system of the present invention is only used on transactions when a credit/debit card is not present.
